(19) United States
(12) Patent Application Publication
(10) Pub. No.: US 2018/0174482 A1
(43) Pub. Date: Jun. 21, 2018

(54) System For Performing Multiplication

(71) Applicant: Mohammad Gheith, Oak Lawn, IL (US)

(72) Inventor: Mohammad Gheith, Oak Lawn, IL (US)

(21) Appl. No.: 15/635,186

(22) Filed: Jun. 27, 2017

Related U.S. Application Data
(63) Continuation-in-part of application No. 14/269,124, filed on May 3, 2014, now abandoned.
(60) Provisional application No. 61/822,876, filed on May 13, 2013.

(51) Int. Cl. G09B 19/02

(52) U.S. Cl. CPC G09B 19/02

(57) ABSTRACT

A system for performing multiplication comprises a surface configured to contain a work area. The work area includes Multiplication, Addition and Answer Zones. In the Multiplication Zone, a pair of multi-digit numbers to be multiplied is displayed such that the digits of one number are vertically aligned with the digits of the other number. The Addition Zone has a top row, a bottom row and a plurality of middle rows, with the rows divided into a number of columns. The Answer Zone consists of a row divided into a number of cells. The products of multiplication and cross-multiplication of the aligned digits are displayed in designated columns and cells in the Addition Zone and Answer Zone such that the sequence of digits in the Answer Zone is the result of the multiplication of the pair of multi-digit numbers.

### CROSS-REFERENCE TO RELATED APPLICATIONS

This application is a continuation-in-part of U.S. non-provisional Ser. No. 14/269,124 filed on May 3, 2014, entitled “Method of Teaching Multiplication to Mathematics Students”. The '124 non-provisional application claimed priority benefits from U.S. provisional patent application Ser. No. 61/822,876 filed on May 13, 2013, entitled “Method of Teaching Multiplication to Mathematics Students”. Each of the '124 non-provisional application and the '876 provisional application is hereby incorporated by reference herein in its entirety.

### FIELD OF INVENTION

The present invention relates to the field of mathematics and, in particular, to a system for performing multiplication.

### BACKGROUND OF THE INVENTION

Individuals acquire analytical skills in different ways. For many individuals, traditional techniques for acquiring and performing mathematical skills, such as multiplication and division, are not as effective as other less conventional, and perhaps previously overlooked, techniques. It is therefore beneficial to have available a portfolio of techniques for acquiring and performing a given mathematical skill so that a individual having difficulty in acquiring the skill using one technique can turn to a different technique that may be better suited to each individual's way of learning and performing mathematical tasks.

In the case of multiplication of multi-digit numbers, the conventional technique involves arranging the digits in columns and keeping track of how many places to proceed to the left as multiplications of individual digits are performed. With larger multi-digit numbers, this conventional technique can get confusing as it is easy to lose track of how many places to the left to arrange the product of each of the two digits being multiplied. Carrying numbers can also be confusing because numbers arranged in columns at the top can get confused as multiple numbers are being carried and arranged on top of the same digit in the original number. Mistakes are also hard to find in this conventional technique when so many digits need to be carefully arranged in proper columns. Adding up the rows of digits at the end of the conventional technique is an extra step that can be subject to error as well.

The present system for performing multiplication provides an alternative approach to multiplying multi-digit numbers that can be understood by individuals who struggle with conventional multiplication techniques. The present system is particularly effective for performing multiplication of large multi-digit numbers.

### SUMMARY OF THE INVENTION

Shortcomings of conventional multiplication techniques are overcome by a system for performing multiplication of two multi-digit numbers. The system comprises:
(a) a surface configured to contain a work area, the work area capable of displaying diagrammatically arranged numerals, the work area comprising:
   (1) a Multiplication Zone configured to display the numerals arranged such that the digits of one number to be multiplied are vertically aligned with the digits of the other number to be multiplied;
   (2) an Addition Zone comprising a top row, a bottom row and a plurality of middle rows, the rows divided into a number of columns corresponding to the sum of the number of digits in the numbers to be multiplied minus one;
   (3) an Answer Zone comprising a row divided into a number of cells corresponding to the sum of the number of digits in the numbers to be multiplied minus one;
(b) a first pivot point indicator displayed beneath the aligned lowest place digits of the numbers to be multiplied displayed in the Multiplication Zone;
(c) first numerals displayed in the middle rows of the rightmost empty column of the Addition Zone, the first numerals corresponding to the results of multiplying the aligned lowest place digits and the results of cross-multiplication of the aligned digits on either side of the first pivot point indicator progressively in pairs until no further pairs can be formed;
(d) a second numeral displayed in the rightmost empty cell in the bottom row of the Addition Zone, the second numeral corresponding to the result of adding together by column the first numerals displayed in the middle rows of the Addition Zone;
(e) a third numeral displayed in the rightmost empty cell of the Answer Zone, the third numeral corresponding to the lowest place digit of the second numerals taken as a single multi-digit number;
(f) a fourth numeral displayed in the next cell to the left in the top row of the Addition Zone, the fourth numeral corresponding to the higher place digits of the second numerals taken as a single multi-digit number;
(g) a next pivot point indicator displayed in the work area between the aligned lowest and next-lowest place digits of the pair of multi-digit numbers to be multiplied in the Multiplication Zone;
(h) fifth numerals displayed in the middle rows of the rightmost empty column of the Addition Zone, the fifth numerals corresponding to the results of cross-multiplying the aligned digits on either side of the next pivot point indicator progressively in pairs until no further pairs can be formed;
(j) a sixth numeral displayed in the rightmost empty cell of the Answer Zone, the sixth numeral corresponding to the result of adding together by column the fifth numerals displayed in the middle rows of the Addition Zone
(k) a seventh numeral displayed in the rightmost empty cell of the Answer Zone, the seventh numeral corresponding to the lowest place digit of the fifth numerals taken as a single multi-digit number;
(l) an eighth numeral displayed in the next cell to the left in the top row of the Addition Zone, the eighth numeral corresponding to the higher place digits of the fifth numerals taken as a single multi-digit number;
(m) further numerals displayed in the Addition and Answer Zones of the work area in accordance with the arrangement of the first through eighth numerals, and first and next pivot point indicators, until the left-most aligned digits of the multi-digit numbers to be multiplied have all been multiplied;

In operation, the result of the multiplication of the pair of multi-digit numbers to be multiplied is displayed as the sequence of digits in the Answer Zone.

In the case of the multi-digit numbers having different lengths, the lengths are made equal by preceding the smaller number with zeroes.

### BRIEF DESCRIPTION OF THE DRAWINGS

FIG. 1A (Prior Art) is a diagram depicting the conventional technique for multiplying two single-digit numbers.

FIG. 1B (Prior Art) is a diagram depicting the conventional technique for multiplying two single-digit numbers in which the work area is divided into zones to facilitate the carrying out of the technique.

FIG. 2A (Prior Art) is a diagram depicting the conventional technique for multiplying two double-digit numbers.

FIG. 2B (Prior Art) is a diagram depicting the conventional technique for multiplying two double-digit numbers in which the work area is divided into zones to facilitate the carrying out of the technique.

FIGS. 3A-3J are schematic diagrams of surfaces configured to contain a work area with displays associated with the present system for performing multiplication of two 5-digit numbers, made up of the digits 1 and 2 for simplicity, in which the work area is divided into zones to facilitate operation of the system.

FIGS. 4A-4J are schematic diagrams of surfaces configured to contain a work area with displays associated with the present system for performing multiplication of two 5-digit numbers, made up of numbers larger than those in FIGS. 3A-3J, in order to demonstrate operation of the present system using more complex numbers.

FIGS. 5A-5N are schematic diagrams of surfaces configured to contain a work area with displays associated with the present system for performing multiplication of two 7-digit numbers.

### DETAILED DESCRIPTION OF PREFERRED EMBODIMENT(S)

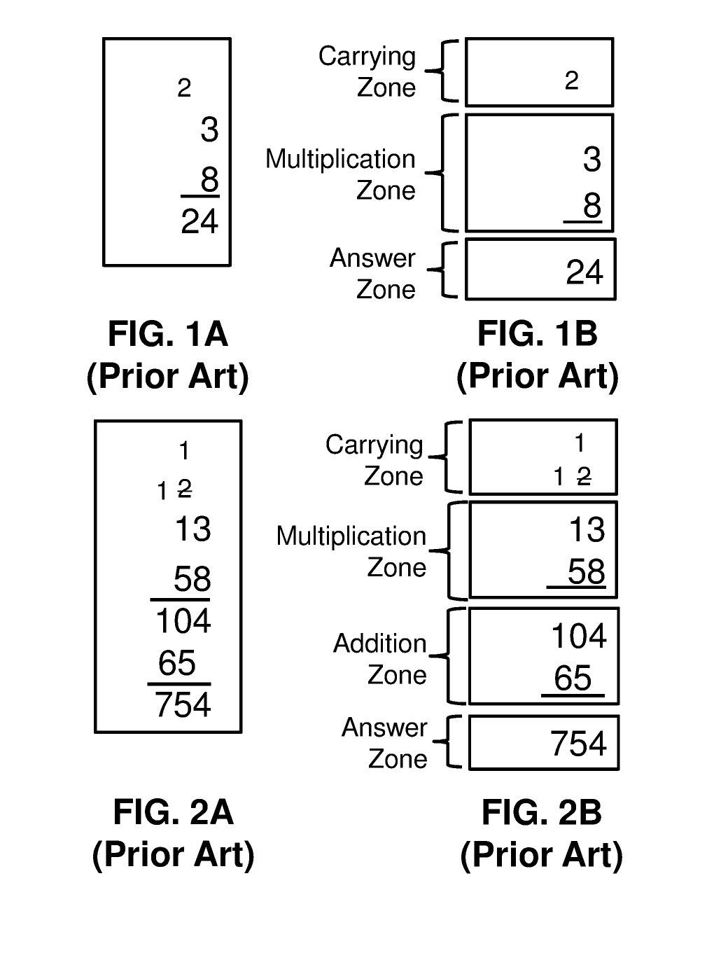

Turning first to FIG. 1A, the conventional technique for performing multiplication involves first arranging the digits of the numbers to be multiplied in columnar fashion with a line drawn beneath the lower number. The digits in the rightmost column are multiplied to produce a product (24), which the individual doing the multiplication must keep in mind. The ones-place (rightmost) digit of the product (4 in the case of FIG. 1A) is placed in columnar fashion beneath the line and the tens-place or left-most digit is placed above the second column of numbers being multiplied. In the case of the single-digit numbers being multiplied in FIG. 1A, there are no digits in the second column, so the tens-place digit placed above that column is simply “added” together with assumed zeroes in the second column to produce a sum (2 in the case of FIG. 1A), which is then placed in columnar fashion beneath the line to produce the result of the multiplication, namely, 24.

FIG. 1B shows in diagrammatic form the multiplication technique described above with reference to FIG. 1A. In FIG. 1B, the work area is divided into a Multiplication Zone, a Carrying Zone and an Answer Zone, which correspond to and, once drawn, facilitate the steps involved in the multiplication technique.

Turning to FIGS. 2A and 2B, the conventional technique for performing multiplication is demonstrated for two double-digit numbers. Once arranged in columnar fashion in the Multiplication Zone as shown in FIG. 2B, the ones-place (rightmost) digits (3 and 8) are multiplied to produce a product (24). The ones-place digit (4) of the product is placed in columnar fashion in the first column of the Addition Zone beneath the line at the bottom of the Multiplication Zone. The tens-place digit (2) of the product is placed in the Carrying Zone above the second column of digits in the Multiplication Zone. Next, the ones-place digit (8) in the lower number and the tens-place digit (1) of the upper number are multiplied to produce a product (8) that must be kept in mind and added to the number (2) in the Carrying Zone to produce a sum (10). The ones-place digit (0) of that sum is placed in the second column in the Addition Zone, and the tens-place digit (1) of that product is placed in the third column of the Carrying Zone. There are no digits in the third column of the Multiplication Zone, so the tens-place digit (1) placed above that is simply “added” to assumed zeroes in the third column of the Multiplication Zone to produce a sum (1), which is then placed in the third column of the Addition Zone beneath the line to produce the result (104) of the first step of the multiplication.

Next, the tens-place digit (5) of the lower number and the ones-place digit (3) of the upper number are multiplied to produce a product (15). The ones-place digit (5) of the product is then placed in the second column of the Addition Zone below the second digit (0) of the prior number (104) in the Addition Zone. The tens-place digit (1) of the product is then placed in the Carrying Zone above the second column in the Multiplication Zone. At the same time, the prior tens-place digit (2) in the Carrying Zone is crossed out so as not to confuse the new tens-place digit (1) with the prior tens-place digit. Next, the tens-place digit (5) of the lower number and the tens-place digit (1) of the upper number are multiplied to produce a product (5), which when added to the new tens-place digit (1) in the Carrying Zone totals to 6. That result is placed in the third column of the Addition Zone. A line is drawn at the bottom of the Addition Zone, and the numbers in the Addition Zone (104 and 65) are then totaled to produce a total (754), which is then placed in the Answer Zone and represents the solution to the problem of multiplying 13 and 58 using the conventional technique for performing multiplication.

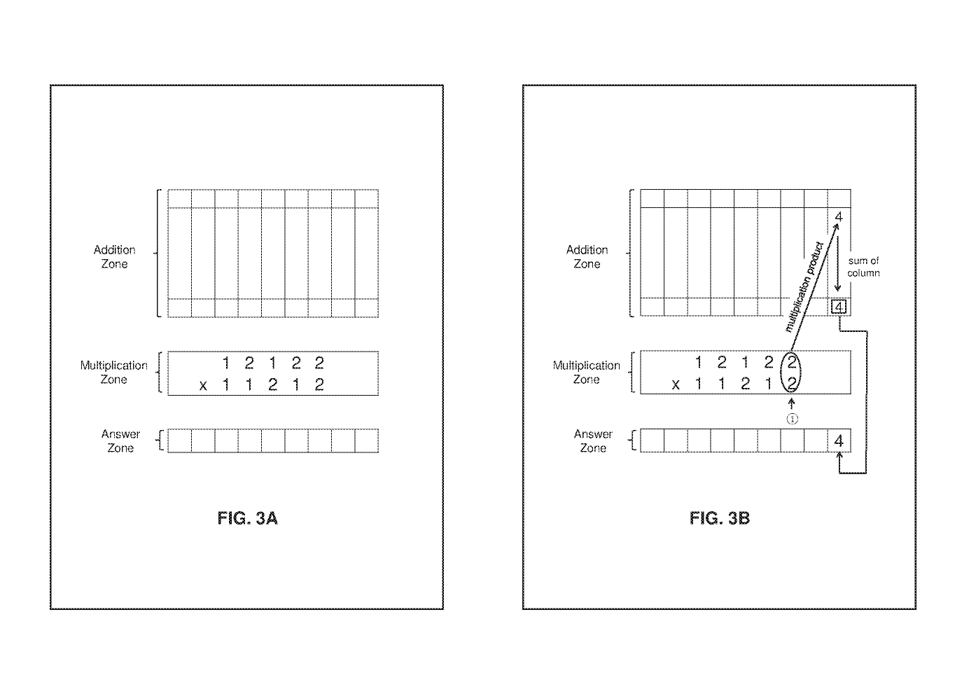

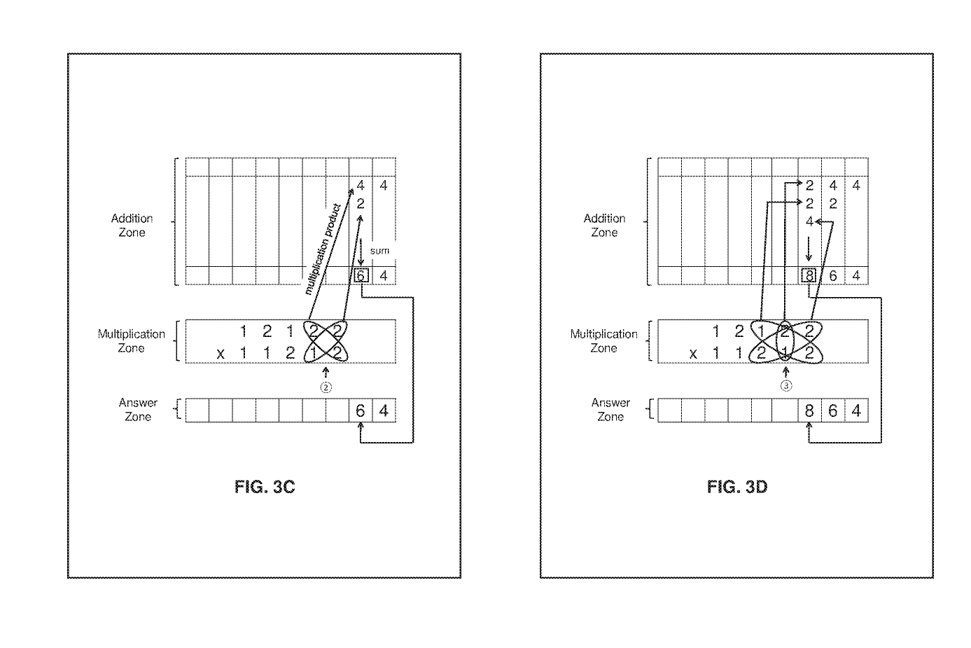

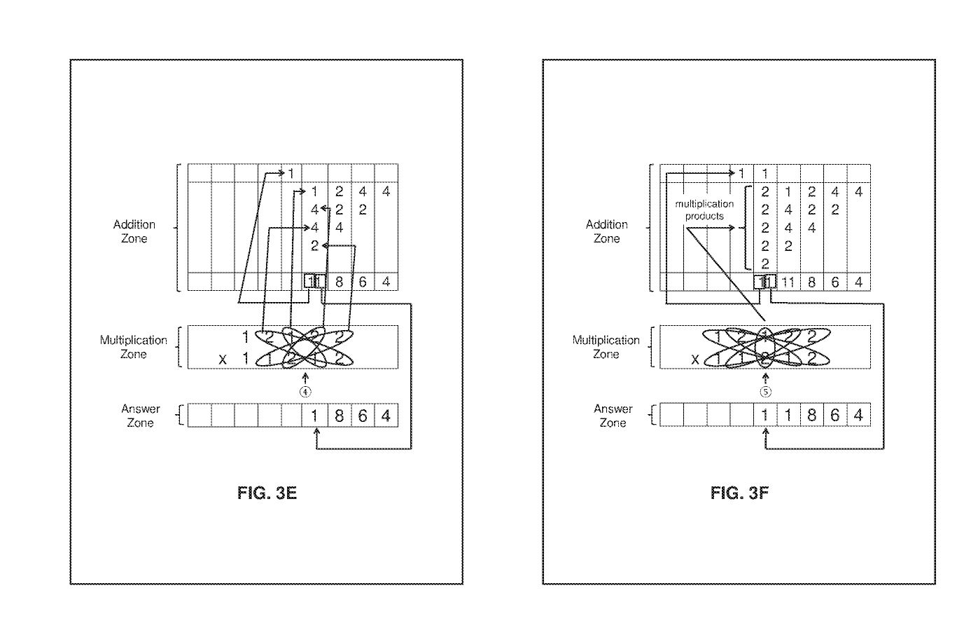

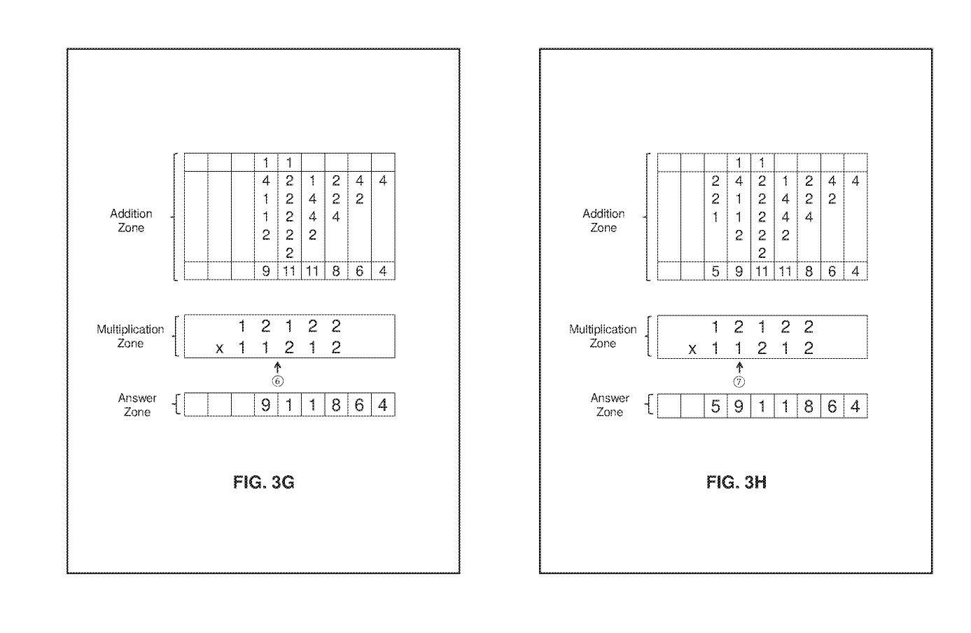

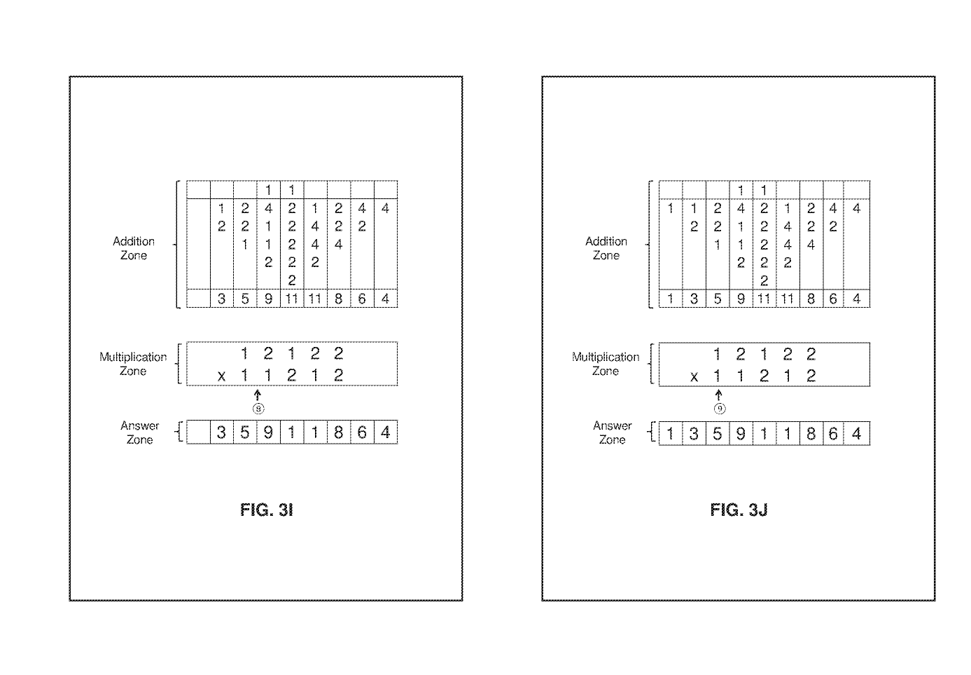

Turning now to FIGS. 3A-3J, the multiplication of two 5-digit numbers (12122 and 11212) will be carried out using the present system. At the outset, and as shown in FIG. 3A, three zones are displayed (for example, drawn) on the work area, the first being the Addition Zone containing a top row, a bottom row and enough space for additional rows. The Addition Zone is also divided into a number of columns corresponding to the number of digits in the numbers being multiplied minus one. In the case of the multiplication operation being commenced in FIG. 3A, there are 10 digits in the numbers being multiplied, so the number of columns in the Addition Zone is 9. Beneath the Addition Zone is the Multiplication Zone, which contains the original numbers to be multiplied. Beneath the Multiplication Zone is the Answer Zone, which consists of one row and, like the Addition Zone, is divided into a number of cells (9) corresponding to the number of digits being multiplied minus one.

FIG. 3B illustrates display \textcircled{1} of the present system. The pivot point indicator is displayed below the first column of digits in the Multiplication Zone. The digits in the first (rightmost) column (2 and 2) are multiplied, and the product (4) is displayed in the first (rightmost) column of the Addition Zone. That column is then summed to produce a total (4), which is displayed in the bottom row of the Addition Zone. The ones-place digit (4) of the sum is then displayed in the first (rightmost) cell in the Answer Zone. (As will be illustrated in some of the later displays described below, if the sum had produced a 2-digit number, then the tens-place digit would have been displayed in the second cell (first to the left of the rightmost column) in the top row of the Addition Zone.)

FIG. 3C illustrates display \textcircled{2} of the present system. As shown, the pivot point indicator is now displayed between the first and second columns of digits in the Multiplication Zone in the Multiplication Zone. The digits in the second column (2 and 1) and the digits in the first column (2 and 2) are cross-multiplied, and the respective products (4 and 2) are then displayed in the second column of the Addition Zone. The numbers in that column are then added to produce a sum (6), which is displayed in the bottom row of the Addition Zone. The ones-place digit (6) is then displayed in the second cell in the Answer Zone.

FIG. 3D illustrates display \textcircled{3} of the present system. As shown, the pivot point indicator is now displayed below the second column of digits in the Multiplication Zone. The digits in the second column (2 and 1) at the pivot point indicator are multiplied first, and the product (2) is displayed in the third column of the Addition Zone. The digits in the column just to the left of the pivot point indicator (1 and 2) and the digits in the column just to the right of the pivot point indicator (2 and 2) are then cross-multiplied, and the respective products (2 and 4) are displayed in the third column of the Addition Zone. The numbers in the third column are then added to produce a sum (8), which is displayed in the bottom row of the Addition Zone. The ones-place digit (8) is then displayed in the third cell of the Answer Zone.

FIG. 3E illustrates display \textcircled{4} of the present system. As shown, the pivot point indicator is now displayed between the second and third columns of digits in the Multiplication Zone. The digits in the third column (1 and 2) and the digits in the second column (2 and 1) are cross-multiplied, and the respective products (1 and 4) are then displayed in the fourth column of the Addition Zone. As further shown in FIG. 3E, the digits in the fourth column (2 and 1) and digits in the first column (2 and 2) are cross-multiplied, and the respective products (4 and 2) are then displayed in the fourth column of the Addition Zone. The numbers in the fourth column are then added to produce a sum (11), which is displayed in the bottom row of the Addition Zone. The ones-place digit (1) is then displayed in the fourth cell in the Answer Zone, while the tens-place digit (1) is displayed in the top row of the fifth column of the Addition Zone, as shown in FIG. 3E.

The cross-multiplication displays depicted in FIG. 3E are important to the understanding of the present system for performing multiplication. The cross-multiplication is carried out on as many columns of digits in the Multiplication Zone as possible on either side of the pivot point indicator until no further cross-multiplications are possible, even though there may be a column remaining on the left or on the right that cannot be paired and therefore cannot participate in the cross-multiplication portion of a display.

FIG. 3F illustrates display \textcircled{5} of the present system. As shown, the pivot point indicator is now displayed below the third column of digits in the Multiplication Zone. The digits in the third column (1 and 2) at the pivot point indicator are multiplied first, and the product (2) is displayed in the fifth column of the Addition Zone. The digits in the column just to the left of the pivot point indicator (2 and 1) and the digits in the column just to the right of the pivot point indicator (2 and 1) are then cross-multiplied, and the respective products (2 and 2) are also displayed in the fifth column of the Addition Zone. There are more cross-multiplications possible to carry out in the Multiplication Zone on either side of the pivot point indicator, and as further shown in FIG. 3F, the digits in the fifth column (1 and 1) and digits in the first column (2 and 2) are cross-multiplied, and the respective products (2 and 2) are then displayed in the fourth column of the Addition Zone. The numbers in the fourth column are then added to produce a sum (11), which is displayed in the bottom row of the Addition Zone. The ones-place digit (1) is then displayed in the fifth cell of the Answer Zone, while the tens-place digit (1) is displayed in the top row of the sixth column of the Addition Zone, as shown in FIG. 3F.

FIG. 3G illustrates display \textcircled{6} of the present system. As shown, the pivot point indicator is now displayed between the third and fourth columns of digits in the Multiplication Zone. The ellipses that illustrated the various cross-multiplications in the previous figures have been omitted to simplify this and subsequent figures, but the same cross-multiplication process applies. Accordingly, the digits in the fourth column (2 and 1) and the digits in the third column (1 and 2) are cross-multiplied, and the respective products (4 and 1) are then displayed in the sixth column of the Addition Zone. The digits in the fifth column (1 and 1) and digits in the second column (2 and 1) are cross-multiplied, and the respective products (1 and 2) are then displayed in the sixth column of the Addition Zone. No further cross-multiplications are possible, so the numbers in the sixth column are then added to produce a sum (9), which is displayed in the bottom row of the Addition Zone. The ones-place digit (9) is then displayed in the sixth cell of the Answer Zone. There is no tens-place digit to be displayed in the top row of the seventh column of the Addition Zone in FIG. 3G.

FIG. 3H illustrates display \textcircled{7} of the present system. As shown, the pivot point indicator is now displayed below the fifth column of digits in the Multiplication Zone. The digits in the fifth column (2 and 1) at the pivot point indicator are multiplied first, and the product (2) is displayed in the seventh column of the Addition Zone. The digits in the column just to the left of the pivot point indicator (1 and 1) and the digits in the column just to the right of the pivot point indicator (1 and 2) are then cross-multiplied, and the respective products (2 and 1) are also displayed in the seventh column of the Addition Zone. No further cross-multiplications are possible, so the numbers in the seventh column are then added to produce a sum (5), which is displayed in the bottom row of the Addition Zone. The ones-place digit (5) is then displayed in the seventh cell of the Answer Zone. There is no tens-place digit to be displayed in the top row of the eighth column of the Addition Zone in FIG. 3H.

FIG. 3I illustrates display \textcircled{8} of the present system. As shown, the pivot point indicator is now displayed between the fourth and fifth columns of digits in the Multiplication Zone. The digits in the fifth column (1 and 1) and the digits in the fourth column (2 and 1) are cross-multiplied, and the respective products (1 and 2) are then displayed in the eighth column of the Addition Zone. No further cross-multiplications are possible, so the numbers in the eighth column are then added to produce a sum (3), which is displayed in the bottom row of the Addition Zone. The ones-place digit (3) is then displayed in the eighth cell of the Answer Zone. There is no tens-place digit to be displayed in the top row of the ninth column of the Addition Zone in FIG. 3I.

FIG. 3J illustrates display \textcircled{9} of the present system. As shown, the pivot point indicator is now displayed below the fifth column of digits in the Multiplication Zone. The digits in the fifth column (1 and 1) at the pivot point indicator are multiplied, and the product (1) is displayed in the ninth column of the Addition Zone. That column is then summed to produce a total (1), which is displayed in the bottom row of the Addition Zone. The ones-place digit (1) is displayed in the ninth (left-most) cell of the Answer Zone in FIG. 3J.

The sequence of digits in the Answer Zone of FIG. 3J (135911864) is the solution to the problem of multiplying 12122 and 11212 using the present system for performing multiplication.

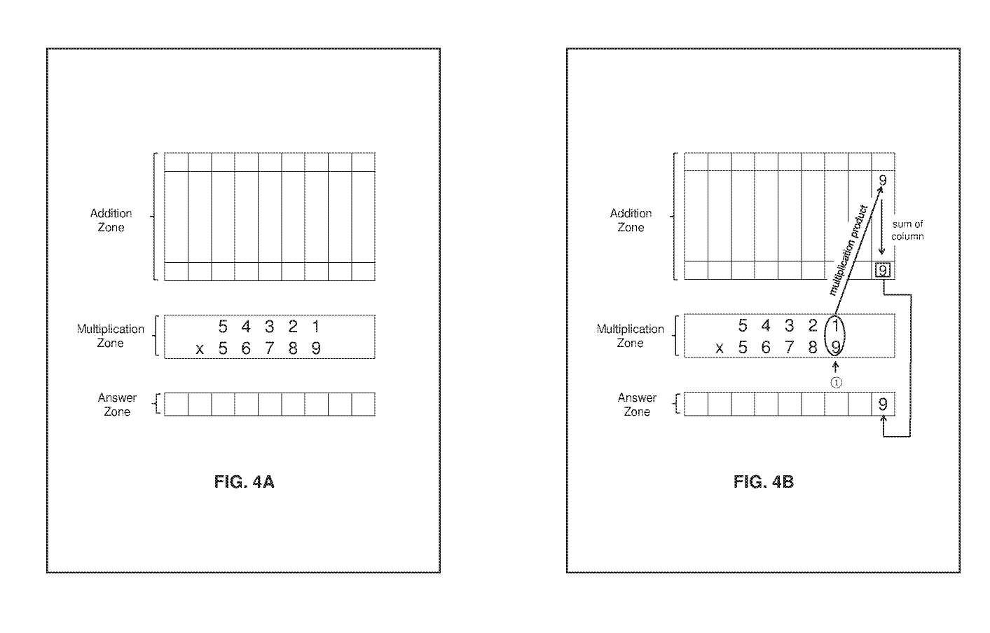

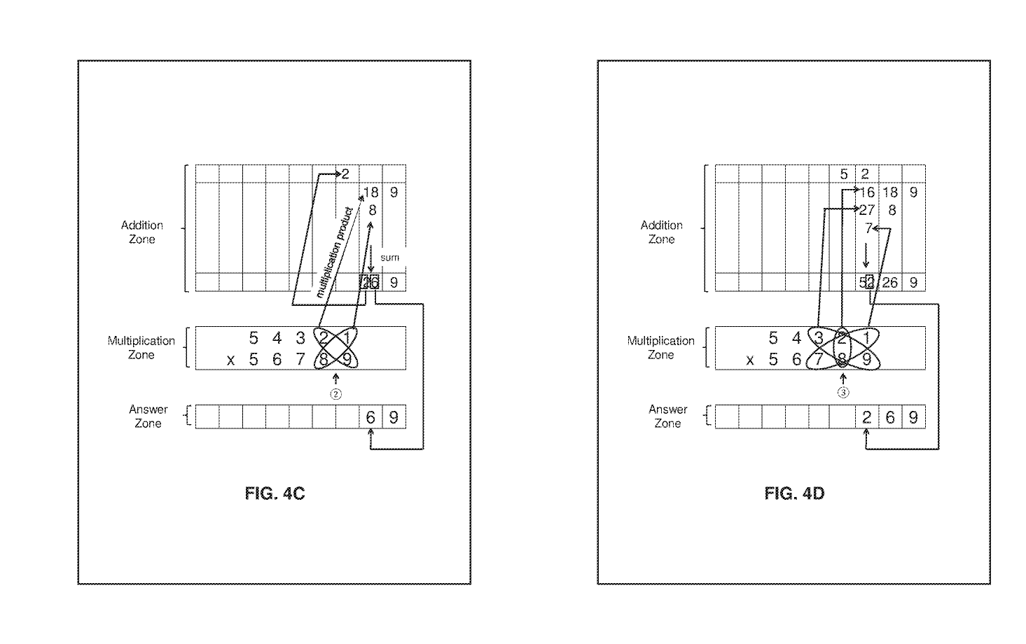

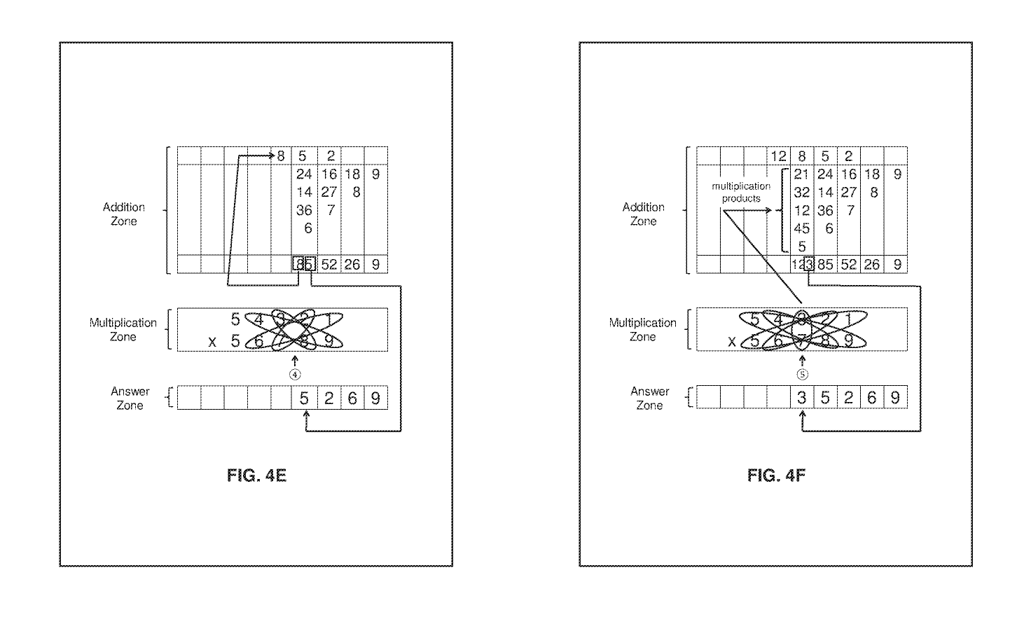

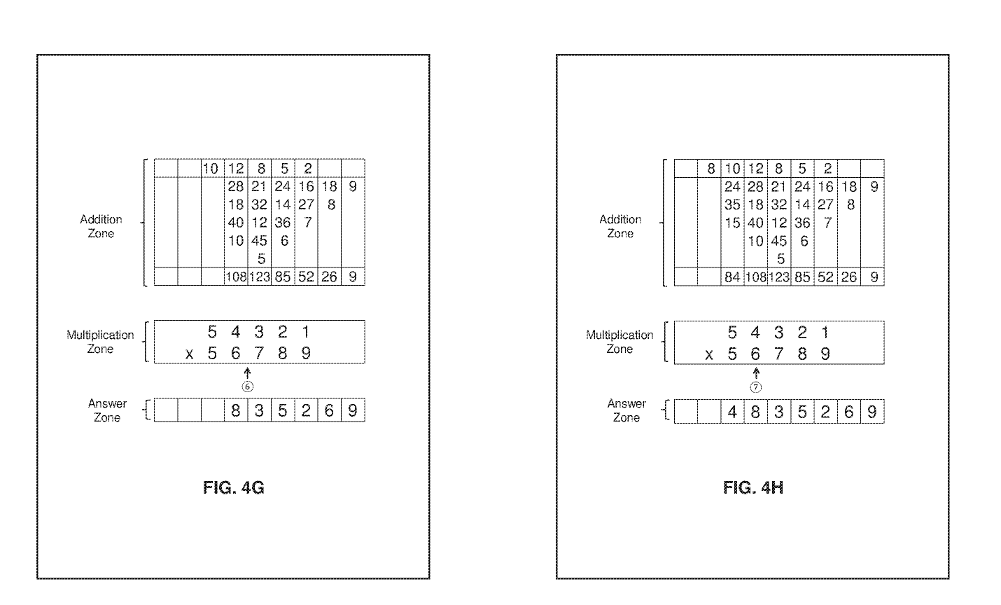

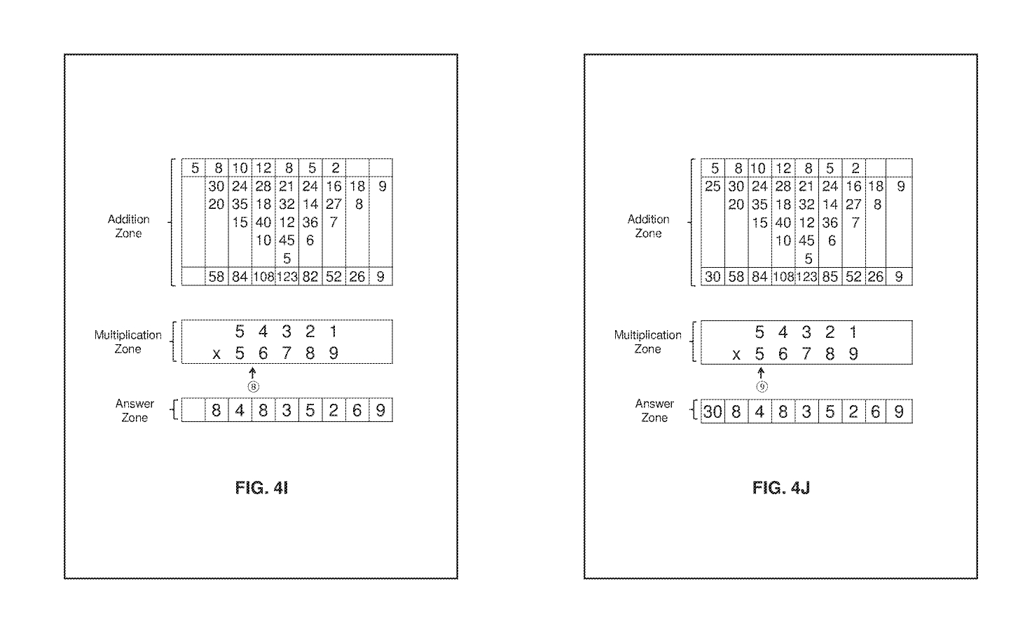

FIGS. 4A-4J illustrate the multiplication on the work area of two 5-digit numbers, made up of larger numbers than those in FIGS. 3A-3J, in order to demonstrate the present system using numbers whose products when multiplied are larger double-digit numbers. The 5-digit numbers being multiplied in FIGS. 4A-4J are 54321 and 56789. At the outset, and as shown in FIG. 4A, the Addition Zone, the Multiplication Zone and the Answer Zone are drawn. The Addition Zone contains a top row, a bottom row, enough space for additional rows, and nine columns, which corresponds to the number of digits in the numbers being multiplied minus one. Beneath the Addition Zone is the Multiplication Zone, which contains the original numbers to be multiplied. Beneath the Multiplication Zone is the Answer Zone, which consists of one row and, like the Addition Zone, is divided into 9 columns.

FIG. 4B illustrates display \textcircled{1} of the present system. The pivot point indicator is displayed below the first column of digits in the Multiplication Zone to be multiplied. The digits in the first (rightmost) column (1 and 9) are multiplied, and the product (9) is displayed in the first (rightmost) column of the Addition Zone. That column is then summed to produce a total (9), which is displayed in the bottom row of the Addition Zone. The ones-place digit (9) is then displayed in the first (rightmost) cell of the Answer Zone.

FIG. 4C illustrates display \textcircled{2} of the present system. As shown, the pivot point indicator is now displayed between the first and second columns of digits in the Multiplication Zone. The digits in the second column (2 and 8) and the digits in the first column (2 and 1) are cross-multiplied, and the respective products (18 and 8) are then displayed in the second column of the Addition Zone. The numbers in that column are then added to produce a sum (26), which is displayed in the bottom row of the Addition Zone. The ones-place digit (6) is then displayed in the second cell of the Answer Zone, while the tens-place digit (2) is displayed in the top row of the third column of the Addition Zone in FIG. 4C.

FIG. 4D illustrates display \textcircled{3} of the present system. As shown, the pivot point indicator is now displayed below the second column of digits in the Multiplication Zone. The digits in the second column (2 and 8) at the pivot point indicator are multiplied first, and the product (16) is displayed in the third column of the Addition Zone. The digits in the column just to the left of the pivot point indicator (3 and 7) and the digits in the column just to the right of the pivot point indicator (1 and 9) are then cross-multiplied, and the respective products (27 and 7) are displayed in the third column of the Addition Zone. The numbers in the third column are then added to produce a sum (52), which is displayed in the bottom row of the Addition Zone. The ones-place digit (2) is then displayed in the third cell of the Answer Zone, while the tens-place digit (5) is displayed in the top row of the fourth column of the Addition Zone in FIG. 4D.

FIG. 4E illustrates display \textcircled{4} of the present system. As shown, the pivot point indicator is now displayed between the second and third columns of digits in the Multiplication Zone. The digits in the third column (3 and 7) and the digits in the second column (2 and 8) are cross-multiplied, and the respective products (24 and 14) are then displayed in the fourth column of the Addition Zone. As further shown in FIG. 4E, the digits in the fourth column (4 and 6) and digits in the first column (1 and 9) are cross-multiplied, and the respective products (36 and 6) are then displayed in the fourth column of the Addition Zone. The numbers in the fourth column are then added to produce a sum (85), which is displayed in the bottom row of the Addition Zone. The ones-place digit (5) is then displayed in the fourth cell of the Answer Zone, while the tens-place digit (8) is displayed in the top row of the fifth column of the Addition Zone, as shown in FIG. 4E.

FIG. 4F illustrates display \textcircled{5} of the present system. As shown, the pivot point indicator is now displayed below the third column of digits in the Multiplication Zone. The digits in the third column (3 and 7) at the pivot point indicator are multiplied first, and the product (21) is displayed in the fifth column of the Addition Zone. The digits in the column just to the left of the pivot point indicator (4 and 6) and the digits in the column just to the right of the pivot point indicator (2 and 8) are then cross-multiplied, and the respective products (32 and 12) are also displayed in the fifth column of the Addition Zone. There are more cross-multiplications possible to carry out on either side of the pivot point indicator, and as further shown in FIG. 4F, the digits in the fifth column (5 and 5) and digits in the first column (1 and 9) are cross-multiplied, and the respective products (45 and 5) are then displayed in the fourth column of the Addition Zone. The numbers in the fourth column are then added to produce a sum (123), which is displayed in the bottom row of the Addition Zone. The ones-place digit (3) is then displayed in the fifth cell of the Answer Zone, while the second and hundreds-place digits (12) are together displayed in the top row of the sixth column of the Addition Zone, as shown in FIG. 4F.

FIG. 4G illustrates display \textcircled{6} of the present system. As shown, the pivot point indicator is now displayed between the third and fourth columns of digits in the Multiplication Zone. The ellipses that illustrated the various cross-multiplications in the previous figures have been omitted to simplify this and subsequent figures, but the same cross-multiplication process applies. Accordingly, the digits in the fourth column (4 and 6) and the digits in the third column (3 and 7) are cross-multiplied, and the respective products (28 and 18) are then displayed in the sixth column of the Addition Zone. The digits in the fifth column (5 and 5) and digits in the second column (2 and 8) are cross-multiplied, and the respective products (40 and 10) are then displayed in the sixth column of the Addition Zone. No further cross-multiplications are possible, so the numbers in the sixth column are then added to produce a sum (108), which is displayed in the bottom row of the Addition Zone. The ones-place digit (8) is then displayed in the sixth cell of the Answer Zone, while the second and hundreds-place digits (10) are together displayed in the top row of the seventh column of the Addition Zone, as shown in FIG. 4G.

FIG. 4H illustrates display \textcircled{7} of the present system. As shown, the pivot point indicator is now displayed below the fifth column of digits in the Multiplication Zone. The digits in the fifth column (4 and 6) at the pivot point indicator are multiplied first, and the product (24) is displayed in the seventh column of the Addition Zone. The digits in the column just to the left of the pivot point indicator (5 and 5) and the digits in the column just to the right of the pivot point indicator (3 and 7) are then cross-multiplied, and the respective products (35 and 15) are also displayed in the seventh column of the Addition Zone. No further cross-multiplications are possible, so the numbers in the seventh column are then added to produce a sum (84), which is displayed in the bottom row of the Addition Zone. The ones-place digit (4) is then displayed in the seventh cell of the Answer Zone, while the tens-place digit (8) is displayed in the top row of the eighth column of the Addition Zone in FIG. 4H.

FIG. 4I illustrates display \textcircled{8} of the present system. As shown, the pivot point indicator is now displayed between the fourth and fifth columns of digits in the Multiplication Zone. The digits in the fifth column (5 and 5) and the digits in the fourth column (4 and 6) are cross-multiplied, and the respective products (30 and 20) are then displayed in the eighth column of the Addition Zone. No further cross-multiplications are possible, so the numbers in the eighth column are then added to produce a sum (58), which is displayed in the bottom row of the Addition Zone. The ones-place digit (8) is then displayed in the eighth cell of the Answer Zone, while the tens-place digit (5) is displayed in the top row of the ninth column of the Addition Zone in FIG. 4I.

FIG. 4J illustrates display \textcircled{9} of the present system. As shown, the pivot point indicator is now displayed below the fifth column of digits in the Multiplication Zone. The digits in the fifth column (5 and 5) at the pivot point indicator are multiplied, and the product (25) is displayed in the ninth column of the Addition Zone. No cross-multiplications are possible to perform, so that column is then summed to produce a total (30), which is displayed in the bottom row of the Addition Zone and which is also displayed in the ninth (left-most) cell of the Answer Zone.

The sequence of digits in the Answer Zone of FIG. 4J (3084835269) is the result of multiplying 54321 and 56789 using the present system for performing multiplication.

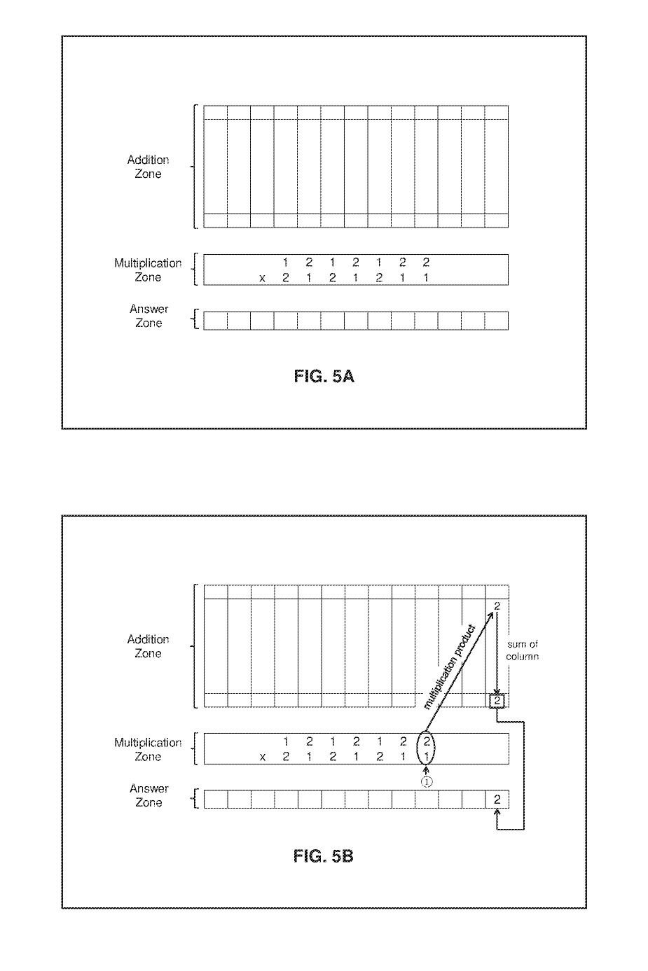

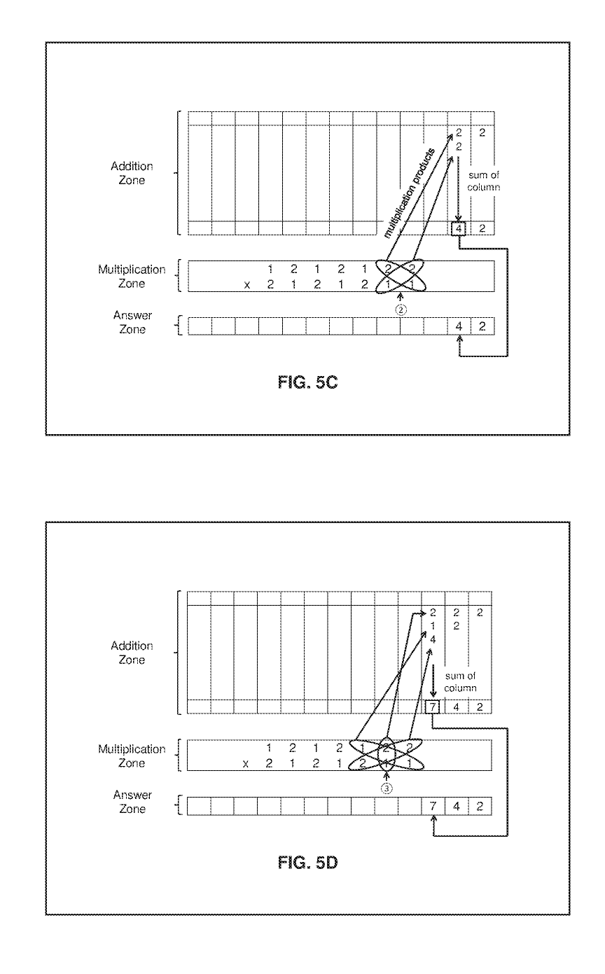

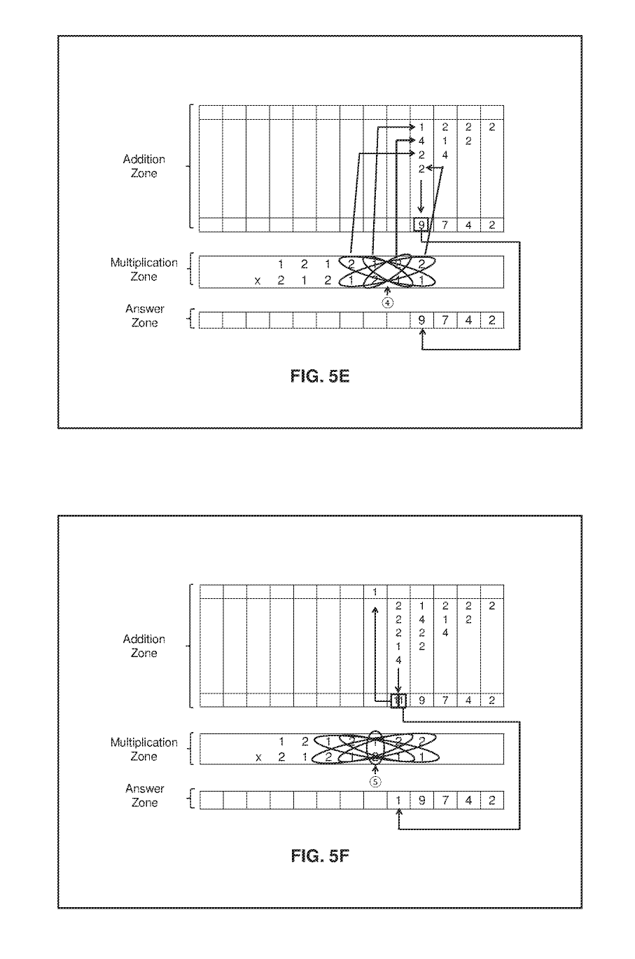

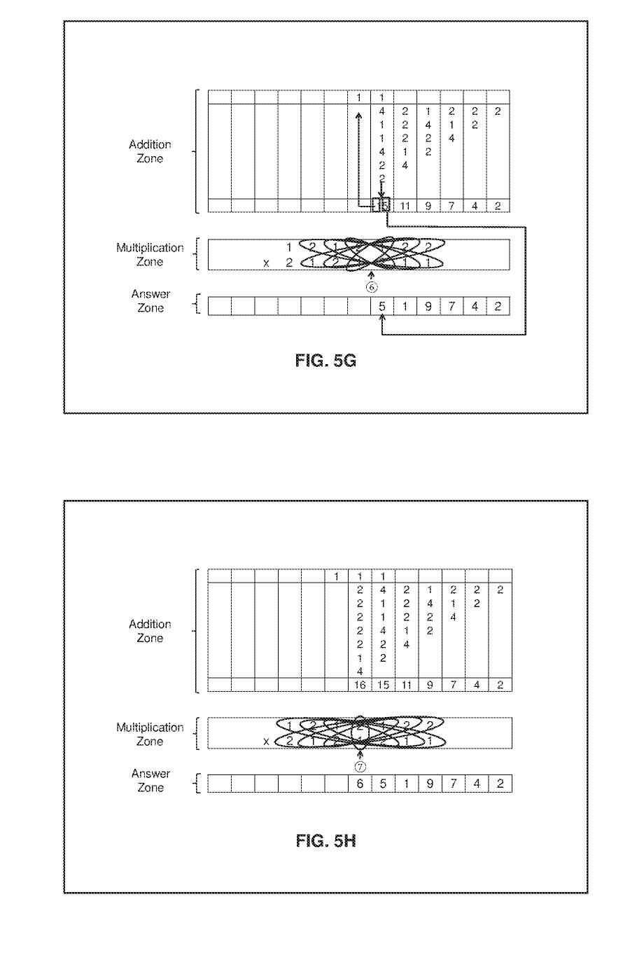

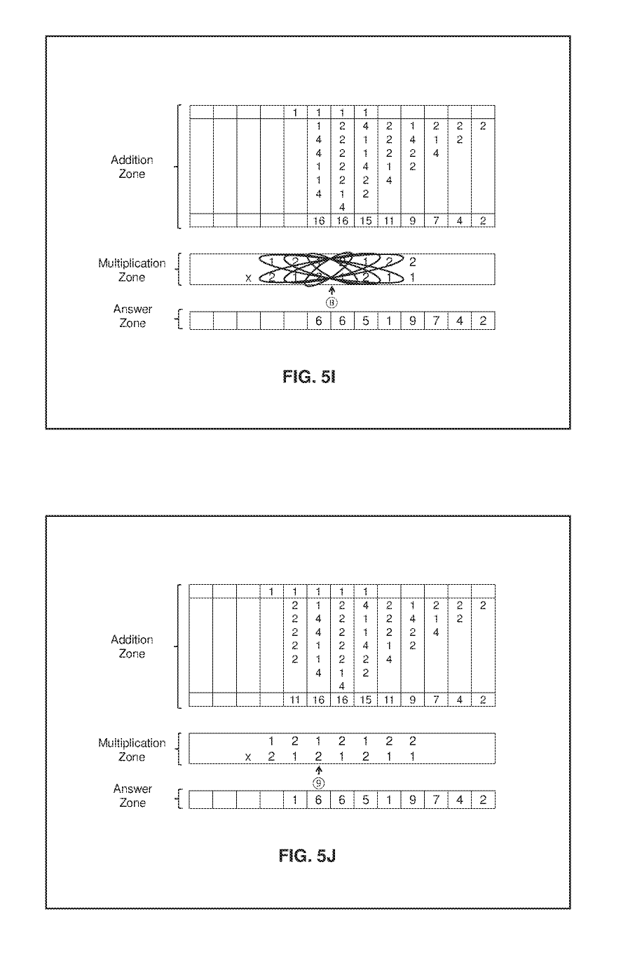

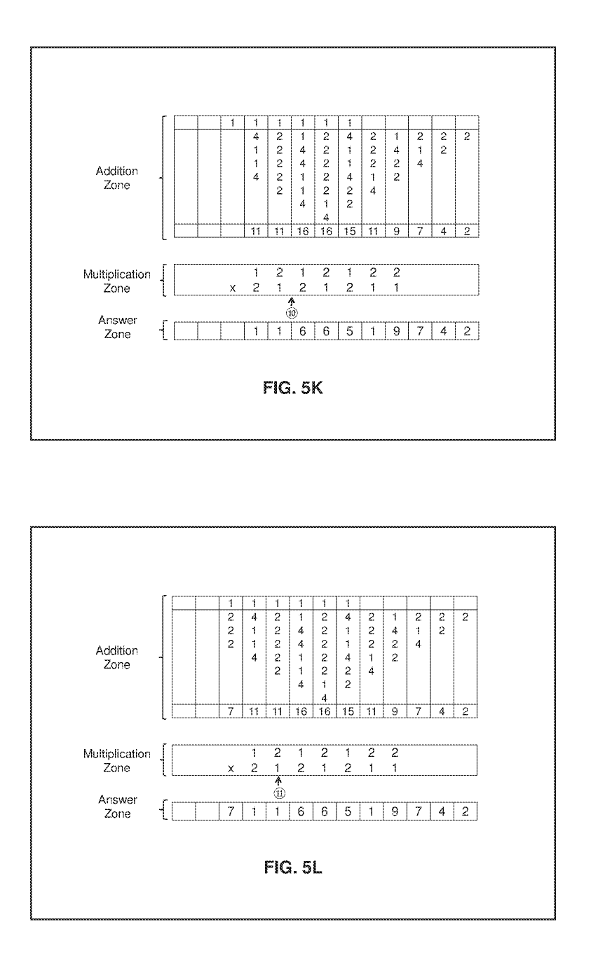

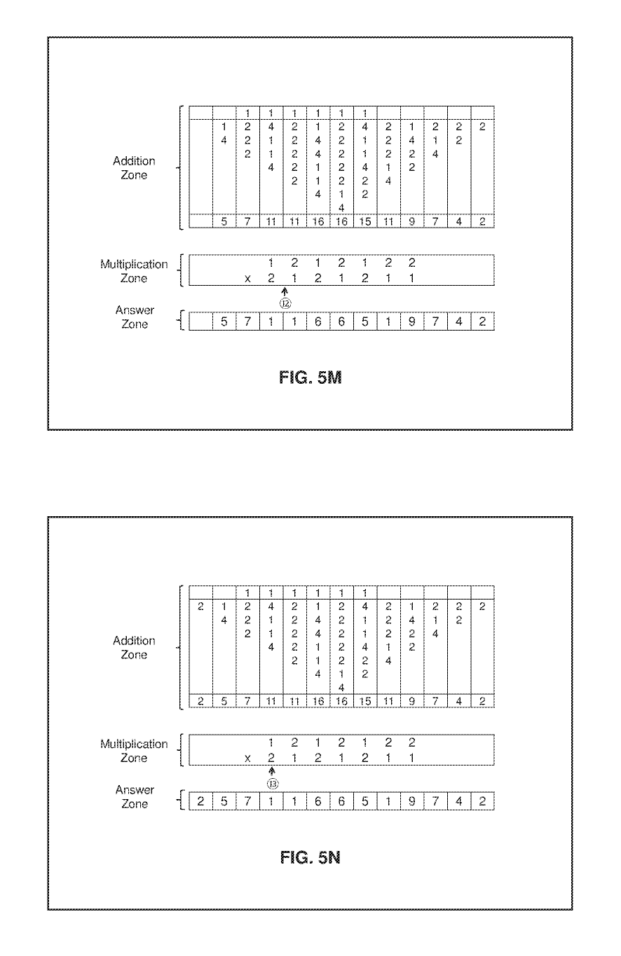

FIGS. 5A-5N are diagrams depicting the progression of displays associated with the present system for performing the multiplication of two 7-digit numbers (1212122 and 2121211). For brevity, the displays associated with that multiplication operation will not be described in this text, since the displays are substantially similar to those carried out in the multiplication operations illustrated in FIGS. 3A-3J and FIGS. 4A-4J, and can be readily understood with reference to FIGS. 5A-5N after having understood the previous figures and accompanying text.

In the present system, where the numbers to be multiplied are of different length, then the smaller number should be preceded by zeroes such that both numbers are of the same length when arranged in the Multiplication Zone. For example, to multiply 78923 with 4567, the numbers should be arranged in the Multiplication Zone as set forth in FIG. 4A.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A system for performing multiplication of two multi-digit numbers, the system comprising:
(a) a surface configured to contain a work area, the work area capable of displaying diagrammatically arranged numerals, the work area comprising:
(1) a Multiplication Zone configured to display the numerals arranged such that the digits of one number to be multiplied are vertically aligned with the digits of the other number to be multiplied;
(2) an Addition Zone comprising a top row, a bottom row and a plurality of middle rows, the rows divided into a number of columns corresponding to the sum of the number of digits in the numbers to be multiplied minus one;
(3) an Answer Zone comprising a row divided into a number of cells corresponding to the sum of the number of digits in the numbers to be multiplied minus one;
(b) a first pivot point indicator displayed beneath the aligned lowest place digits of the multi-digit numbers to be multiplied displayed in the Multiplication Zone;
(c) first numerals displayed in the middle rows of the rightmost empty column of the Addition Zone, the first numerals corresponding to the results of multiplying the aligned lowest place digits and the results of cross-multiplication of the aligned digits on either side of the first pivot point indicator progressively in pairs until no further pairs can be formed;
(d) a second numeral displayed in the rightmost empty cell in the bottom row of the Addition Zone, the second numeral corresponding to the result of adding together by column the first numerals displayed in the middle rows of the Addition Zone;
(e) a third numeral displayed in the rightmost empty cell of the Answer Zone, the third numeral corresponding to the lowest place digit of the second numerals taken as a single multi-digit number;
(f) a fourth numeral displayed in the next cell to the left in the top row of the Addition Zone, the fourth numeral corresponding to the higher place digits of the second numerals taken as a single multi-digit number;
(g) a next pivot point indicator displayed in the work area between the aligned lowest and next-lowest place digits of the pair of multi-digit numbers to be multiplied in the Multiplication Zone;
(h) fifth numerals displayed in the middle rows of the rightmost empty column of the Addition Zone, the fifth numerals corresponding to the results of cross-multiplying the aligned digits on either side of the next pivot point indicator progressively in pairs until no further pairs can be formed;
(j) a sixth numeral displayed in the rightmost empty cell of the Answer Zone, the sixth numeral corresponding to the result of adding together by column the fifth numerals displayed in the middle rows of the Addition Zone
(k) a seventh numeral displayed in the rightmost empty cell of the Answer Zone, the seventh numeral corresponding to the lowest place digit of the fifth numerals taken as a single multi-digit number;
(l) an eighth numeral displayed in the next cell to the left in the top row of the Addition Zone, the eighth numeral corresponding to the higher place digits of the fifth numerals taken as a single multi-digit number;
(m) further numerals displayed in the Addition and Answer Zones of the work area in accordance with the arrangement of the first through eighth numerals, and first and next pivot point indicators, until the left-most aligned digits of the multi-digit numbers to be multiplied have all been multiplied;
whereby the result of the multiplication of the pair of multi-digit numbers to be multiplied is displayed as the sequence of digits in the Answer Zone.

2. The system of claim 1, wherein multi-digit numbers of different length are made equal in length by preceding the smaller number with zeroes.
